(19) United States
(12) Patent Application Publication
(10) Pub. No.: US 2019/0093839 A1
(43) Pub. Date: Mar. 28, 2019

(54) Fire and Heat Display

(71) Applicants: Mark W. Fuller, Sun Valley, CA (US); James W. Doyle, Sun Valley, CA (US)

(72) Inventors: Mark W. Fuller, Sun Valley, CA (US); James W. Doyle, Sun Valley, CA (US)

(21) Appl. No.: 16/137,263

(22) Filed: Sep. 20, 2018

Related U.S. Application Data
(60) Provisional application No. 62/561,158, filed on Sep. 20, 2017.

(51) Int. Cl. F21S 10/04; F24C 7/00

(52) U.S. Cl. CPC F21S 10/04; F24C 7/004

(57) ABSTRACT

A display generally comprising a container that contains a source of combustion and a heat exchange assembly positioned above the source of combustion is disclosed. The heat exchange assembly is heated by the source of combustion and air passing through the assembly is heated and directed to the surrounding area around the display.

### CROSS-REFERENCE TO RELATED APPLICATION

This application claims the benefit of U.S. Provisional Application No. 62/561,158, filed Sep. 20, 2017, the contents of which are incorporated herein by reference.

### FIELD OF THE INVENTION

The current invention generally relates to displays, visual effects and sources of heat. In particular, the current invention relates to fire displays including fire pits.

### BACKGROUND OF THE INVENTION

Fire displays have been in use for many years to provide comfortable visual ambiances for indoor/outdoor gathering areas such as patios, balconies, pools, lobbies, restaurants and bars. Some such displays may consist of a metal pan or dish that may include a natural gas burner below a level of lava rocks, crushed glass or other medium that may cover or otherwise hide the burner mechanics. The fire may emit from the burner and flow upward through the rocks to be visible from above. This type of fire display may also be known as a fire pit.

Other examples of fire pits may include structures that may be built of bricks or tiles, and that may be above or below ground level. These structures may also include burners with flames extending above a covering medium.

In addition, these types of fire displays may also burn other types of combustible materials such as wood, coal or other types of material.

In any event, these fire pits while enjoyable to look at are not generally efficient sources of heat. The flames extend up and into open sky such that the heat is dissipated upward and not outward towards persons positioned about the circumference of the display. In addition, there is very little heating of the lava rocks or other covering medium. The amount of heat that is provided to the viewers is very small unless the fire becomes so large that it may be hazardous.

Accordingly, there is a need for an innovative fire pit that may be an efficient source of heat in addition to being a visual fire display.

### SUMMARY OF THE INVENTION

In a first aspect of the invention, a display is described that may include fire and heat. The display may include a dish, a source of combustion within the dish, and a heat exchange assembly that may be heated by the source of combustion and that may disperse the heat outward to viewers of the display.

In another aspect of the invention, the display may include a container made of metal or other type of fire resistant material. In this aspect, the container may be configured to hold the source of combustion as well as the heat exchange assembly.

In another aspect of the invention, the source of combustion may be a gas burner that may emit flames in an upward direction. The source of combustion may also include an ignition source.

In another aspect of the invention, the display may include a heat exchange assembly that may comprise tubes or pipes that may be positioned above the source of combustion. In this way, the source of combustion may heat at least a portion of the assembly that may be immersed or in close proximity to the flames.

In another aspect of the invention, the heat exchange assembly may include one or more air blowers that may force air into the assembly. The air may travel through the assembly at enough pressure to pass through the assembly and out the assembly outputs.

In another aspect of the invention, the air intake of the air blower may be located outside the container in order to intake fresh air.

In another aspect of the invention, the air blower may be either outside or inside the container.

In another aspect of the invention, the outputs of heat exchange assembly may be located in the lower portion of the container.

In another aspect of the invention, the heat exchange assembly may include a downward section through which air may pass from an upper portion that may be immersed in the flame to the lower positioned outputs.

In another aspect of the invention, the heat exchange assembly may include an upward section through which air may travel from the air blower to the upper portion of the assembly that may be immersed in the flames.

In another aspect of the invention, the heat exchange assembly may include a grid of pipes.

In yet another aspect of the invention, the heat exchange assembly may include a pipe spider.

In another aspect of the invention, the display may combust other combustible materials such as wood and coal.

In another aspect of the invention, the container may include side doors that may allow the wood or coal to be placed within the container below the heat exchange assembly.

In another aspect of the invention, a segment of the heat exchange assembly may rotate upward to allow the wood or coal to be placed within the container below the heat exchange assembly. Once the combustible material is placed within the container the segment may be returned to its original position.

In yet another aspect of the invention, a segment of the heat exchange assembly may be removable to allow the wood or coal to be placed within the container below the heat exchange assembly. Once the combustible material is placed within the container the segment may be replaced to its original position.

Other aspects of the invention are discussed herein.

### BRIEF DESCRIPTION OF THE DRAWINGS

FIG. 1 is a side cut-away view of a fire display.

FIG. 2 is a side cut-away view of a fire display.

FIG. 3 is a top view of a pipe grid.

FIG. 4 is a top view of a pipe spider.

FIG. 5 is a side cut-away view of a fire display.

FIG. 6 is a side cut-away view of a fire display.

FIG. 7 is a side cut-away view of a fire display.

### DETAILED DESCRIPTION OF THE PREFERRED EMBODIMENTS

The following detailed description is not intended to limit the current invention. Alternate embodiments and variations of the subject matter described herein will be apparent to those skilled in the art.

The display 10 of the current invention, the visual effects that it may produce, and the benefits of its functionality are now described with reference to the figures. Where the same or similar components appear in more than one figure, they are identified by the same or similar reference numerals.

In general, display 10 includes a fire display that may provide dramatic visual effects and heat to its viewers. The fire display may include a heat exchange assembly that may extract heat from the display and deliver it safely to neighboring areas. For example, display 10 may be in the form of an innovative fire pit that viewers may generally gather around to enjoy its beauty as well as the warmth it provides. Display 10 may be installed in outdoor areas such as in atriums, balconies, courtyards, parks, camping sites, outdoor dining and bars, poolside and/or in other outdoor areas. Device 10 may also be installed in indoor areas such as at ski lodges, national park lodges, hotel lobbies, indoor atriums, indoor dining or bars and/or in other indoor areas. As such, display 10 may provide an attraction as well as heat to these buildings and spaces. Display 10 may also be included in existing fire, water and/or lighting displays to provide enhanced visual effects and/or heat to its viewers.

As shown in the figures, display 10 may include container 100, combustion source 200 and heat exchange assembly 300. Additional components and/or assemblies may also be included and may be described in later sections. In general, combustion source 200 may be configured within container 100 to provide flames of fire. Heat exchange assembly 300 may be configured with combustion source 200 to extract heat from the flames and provide it to neighboring areas of display 10. Heat exchange assembly 300 may comprise a network of tubes, pipes, manifolds, or other types of devices that may allow air to pass through them. The assembly 300 may also include an air blower that may force air into, through and out the assembly 300. The assembly 300 may be immersed within or in close proximity to the flame such that the flame may heat the pipes and the air traveling within. The heated air may then be vented out or otherwise delivered to areas adjacent to the display 10 to provide warmth. In addition, the flame may extend upward past the heat exchange assembly 300 and be visible towards the top or above the container 100 to provide a visual attraction.

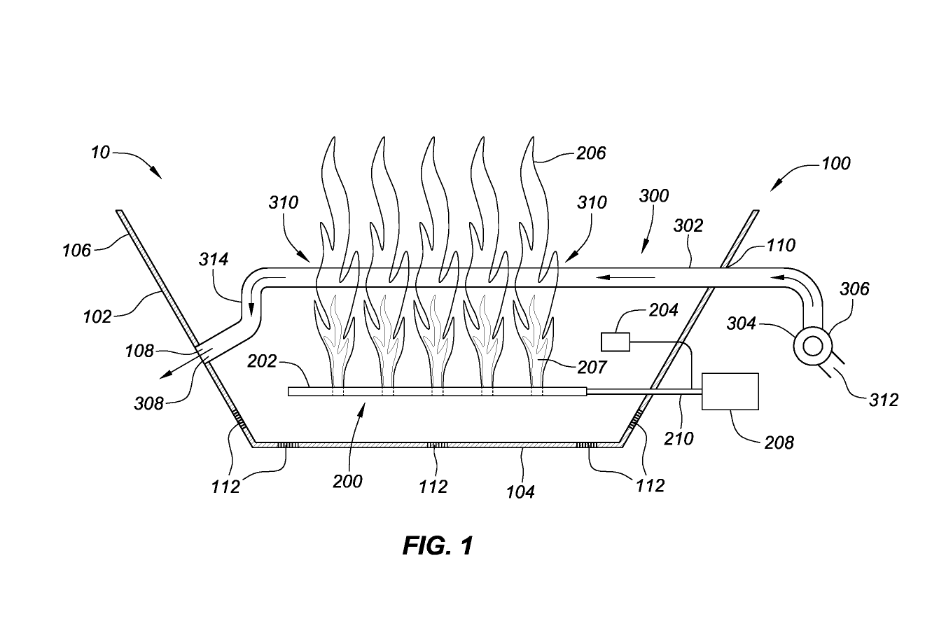

Referring now to FIG. 1, container 100 will be described in further detail. Container 100 may generally include a concave vessel such as a pan 102, dish or tray that may comprise steal, copper, aluminum, carbon or other heat/fire resistant materials. Container 100 may also be of any shape such as circular, square, rectangular, oval shaped, triangular or any other shape. In addition, it may be of any size and diameter such as 10 cm up to 10 meters or more.

Container 100 may also include a pit that may be formed above or below ground, cut into the Earth or built using bricks, tiles, ceramic, stone masonry, cement or other heat/flame resistant materials. In any event, container 100 may generally include a bottom 104 and sides 106 so that it may support and/or otherwise contain the various components and assemblies of display 10 and the flames that it may produce. Container 100 may also include a top such as a grating or other type of top that may provide safety from the flames while allowing the flames to be visible. In this scenario, it may be preferable for the top to allow air to pass in and out of the container 100 in order to provide oxygen to the flames as well as a release path for any smoke or other gasses that may be present. In general, container 100 may be any type of container, vessel or enclosure that may adequately support and contain the various components and assemblies of display 10.

Moving forward, in one example as shown in FIG. 1, combustion source 200 may include a burner 202, combustion chamber, flame holder, nozzle, or other types or combinations of types of gas release mechanisms that may release flammable gas in a generally controlled manner to be set afire. Combustion source 200 may include output orifices, ports or nozzles that may release the gas to be ignited and burned. Combustion source 200 may also include an ignition source 204 that may ignite the flammable gas as it emits from combustion source 200. Note that ignition source 204 may be a pilot light, a flame or series of flames, a burner, a spark, a hot surface or element, or any other type of ignition source 204, and may be generally configured above combustion source 200 such the that flammable gas emitted by burner 202 may travel upward and be ignited. This may result in flames 206. In addition, container 100 may include vents 112 in its bottom 104 and/or sides 106 that may allow for air to vent into container 100 to provide an oxygen source necessary for combustion source 200 to combust. Other types of oxygen sources may also be used.

The flammable gas may be provided to combustion source 200 from a gas supply 208 that may be configured with display 10 or provided from another source via gas pipe 210 as well known in the art. The gas supply 208 may be configured outside container 100, inside container 100 or in any combination thereof. Also note that ignition source 204 as depicted as a pilot light in FIG. 1 may receive flammable gas from gas supply 208 or from another source. The flammable gas may be propane, natural gas (methane), butane, ethylene, hydrogen, acetylene, ammonia, ethane, or any other types or combination of types of flammable gas that may adequately ignite to create flames 206.

As also shown in FIG. 1, display 10 may include heat exchange assembly 300 that may comprise a network of tubes 302, pipes, manifolds, or other types of devices that may generally hold or otherwise contain air. The assembly 300 may include at least one input 306 and at least one output 308, and the portions of heat exchange assembly 300 between the input 306 and the output 308 may be air tight and free of holes and gaps. In this way, heat exchange assembly 300 may provide an airtight passageway for air or other gasses to pass from its input 306 to it output 308.

Note that while FIG. 1 shows one input 304 and one output 308 of heat exchange assembly 300 (shown as tube 302 in FIG. 1), heat exchange assembly 300 may include multiple inputs 304 and outputs 308. For example, heat exchange assembly 300 may comprise a network of tubes 302 as will be described in further detail in later sections.

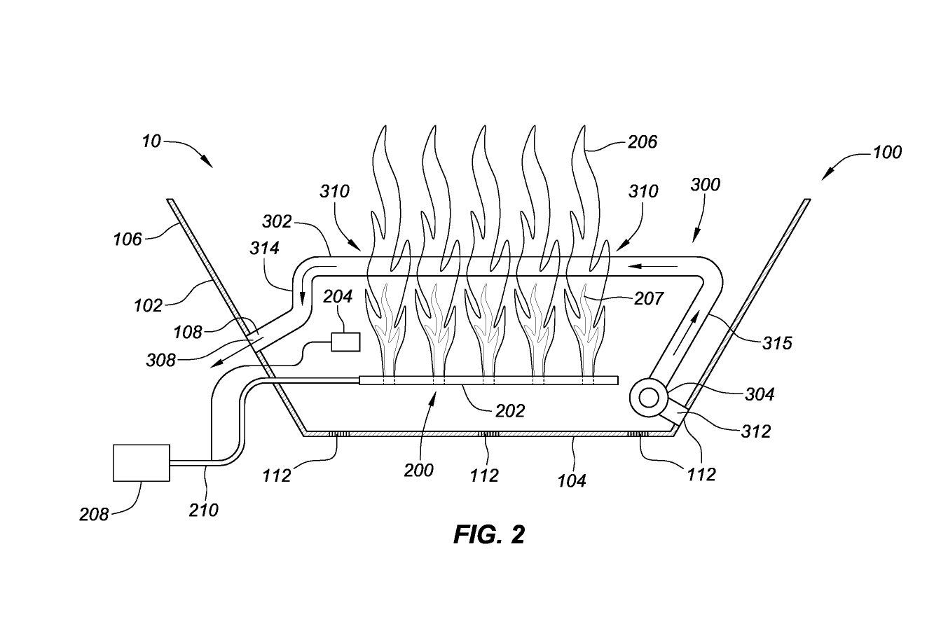

As shown in FIGS. 1, 2, 5, 6 and 7 heat exchange assembly 300 may include a portion 310 that may be configured and positioned above combustion source 200 (burner 202 in the example depicted in FIG. 1 and FIG. 2) such that it may pass through or otherwise be immersed in flames 206. In addition, portion 310 may be in close proximity to flames 206 (for example, within 0.1 cm to 20 cm). In any event, portion 310 may be heated by the flames 206, and in turn, may heat the air inside the tubes 302, especially the air within portion 310. It may be preferable for portion 310 to be located immediately above the burner 202 so that it may pass through the lower portion of the flames 206 where there may be a significant amount of heat. In addition, it may be preferable for some of portion 310 to pass directly through the top tip of the primary flame 207 of flame 206 (as shown in FIG. 1 and FIG. 2). The primary flame 207 is known in the art as the first inner flame above the output gas nozzle of burner 202. It is also well known in the art that the tip of the primary flame 207 is the hottest portion of the flame 206.

If natural gas (Methane) is used, the temperature of flame 206 may be approximately 1950° C. (3542° F.), and if Propane is used, the temperature of flame 206 may be approximately 2800° C. (5072° F.). Other temperatures for other types of flammable gas are known in the art. With portion 310 positioned above the combustion source 200 and immersed or in close proximity to flame 206 at these temperatures, a portion of this heat may be transferred to portion 310 and to the air inside through conduction and convection. Note that portion 310 may be located in any position with regard to flames 206 in which it may receive heat from the flames 206.

Heat exchange assembly 300 may also include one or more air blowers 304 that may generally blow air into one or more of its inputs 306. Air blower 304 may include blowers, fans, sources of pressurized air, or other devices that may force air into the input 306 of heat exchange assembly 300 at an adequate pressure [EXAMPLE PSI RANGES] so that it may enter input 306 and exit output 308 at a substantial pressure. In fact, it may be preferable for the air to exit outputs 308 as a gentle steam of air. Air blower 304 may include an electric motor, a gas engine, an air pressure motor or any other type of device that may adequately power air blower 304. In addition, air blower 304 may be powered by an electrical outlet, a battery, petroleum, a solar panel or by other types or combination of types of power sources. In this way, the air may generally travel from the input 306 to out the output 308. This path is generally depicted by the airflow arrows within tube 302 in FIGS. 1, 2, 5, 6 and 7. Along the way, the air may pass through portion 310 where it may be heated. The heated air may then continue along its path and be released out of the output ports 308.

The air intake port 312 to air blower 304 may be located outside the container 100 so that the air traveling into air blower 304 and through heat exchange assembly 300 may be fresh and never subject to mixing with any combustion products that may result from display 10. For example, air blower 304 may be located generally outside container 100 as depicted in FIG. 1 such that air intake port 312 may also be outside container 100. In this configuration, heat exchange assembly 300 may extend from air blower 304 and enter opening 110 of container 100. Assembly 300 may then extend into container 100 and include heated portion 310 and output port 308 as described above. It should be noted that while FIGS. 1, 2, 5, 6, and 7 depict a single air blower 304, the assembly 300 may include more than one air blowers 304. In addition, while FIG. 1 depicts heat exchange assembly 300 as entering container 100 through a single input opening 110 and exiting through a single output opening 108, the assembly 300 may enter and exit container 100 through a multitude of input openings 110 and output openings 108 that may be configured and positioned in any areas on container 100. This will be described in further detail in later sections.

In another example as shown in FIG. 2, air blower 304 may be configured to be generally within container 100. In this configuration, heat exchange assembly 300 may also be generally inside container 100 as shown and may therefore not require an input opening 110 to enter into the container 100. However, in order to receive fresh air into air blower 304, air intake 312 may be configured with opening 112 in container 100 so that air intake 312 may receive fresh air from outside the container 100. This configuration may allow display 10 to be self-contained so that it may be easily moved from one location to another.

As the heated air from portion 310 travels through the remainder of heat exchange assembly 300 and out its output port 308, it may exit container 100 through opening 108. Note that opening 108 may include a grating or a filter, or may be generally open. In this way, the heated air may be delivered to areas surrounding display 10, for example, to patrons who may be sitting next to display 10 while enjoying its visual flame display and the warmth it may provide.

As shown in FIG. 1 and FIG. 2, output port 308 configured with output opening 108 may be generally located in the lower portion of the sides 106 of container 100. For example, if the display 10 is above ground, the output openings may be 1 cm to 10 cm above the ground. In this way, the exiting heated air streams may heat viewers' feet, legs and bodies. In addition, it is well known in the art that hot air rises. Given this, releasing the hot air streams from a lower starting point may allow for the heat to disperse over a larger radius surrounding display 10. Also, display 10 may include a multitude of output ports 308 and output openings 108 that may be positioned and configured in any locations on container 100.

In addition, it should be noted that this lower positioning of output port 308 and output opening 108 may require heat exchange assembly 300 to include downward portion 314 that may generally extend from an area higher up within container 100 (for example, in the area of portion 310 that may be above combustion source 200 and immersed in flames 206) to the lower location of output port 308 and output opening 108. In this way, air may be heated in the upper portion 310 and then travel downward through downward portion 314 and out output port 308 and output opening 108. Also, if there are more than one output ports 308 and more than one output openings 108, it may be required for there to be more than one downward portion 314, with each downward portion 314 configured to accommodate the different output ports 308 and output openings 108. Note that output port 308 and output opening 108 may be to the side and/or below the combustion source 200. Also note that if one or more air blowers 304 are positioned below portion 310 that one or more upward sections 315 may be required to carry the air from air blowers 304 upward to portion 310.

Output ports 308 may also extend out from openings 108 and/or be directed in any orientation (for example upward, downward, to the left or right, or in any other direction). For example, if the body of display 10 is below ground level, output ports 308 may extend out from openings 108 and then extend upward to a position above the ground to release the heated air. In addition, output ports 308 may also include fan shaped output orifices to spread out the emitted air, converging nozzles to accelerate the emitted air, or other types of nozzles or output orifices to generally affect the output streams of air. These features may allow the heat to be directed in any direction and to any location as necessary.

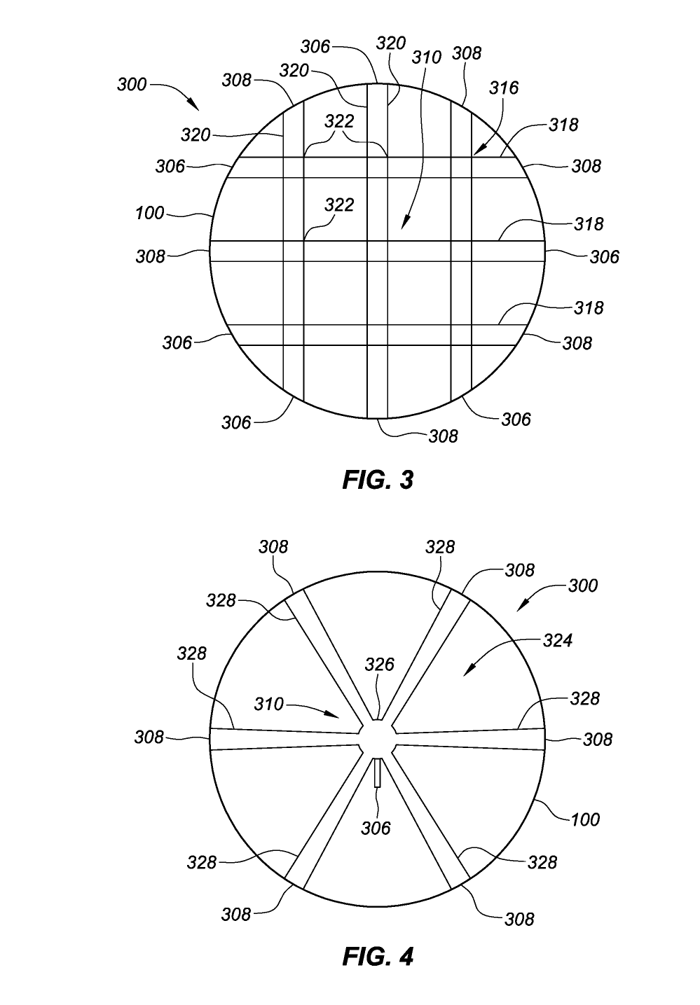

Moving forward, the configuration of heat exchange assembly 300 will now be described with relation to FIGS. 3 and 4. As shown in these figures, heat exchange assembly 300 may include pipes 302 that may be networked in a variety of shapes and configurations. Pipes 302 may have a diameter that may be large enough to allow a sufficient amount of airflow to pass through the pipes (for example, 1 cm to 5 cm), and may comprise a fire resistant material like metal. It may also be preferable that the material have a high thermal conductivity coefficient in order to propagate heat. Such materials may include copper, aluminum, steel and other types of materials.

In one example of this type as shown in FIG. 3, heat exchange assembly 300 may include a pipe grid 316 that may comprise pipes 318 that may be generally parallel with each other, and pipes 320 that may also be generally parallel with each other but generally perpendicular to pipes 318. Each pipe 318, 320 may include an input 306 and an output 308. It can be seen from the description above that air blowers 304 may be configured with one or more inputs 306 such that the air may travel into and through heat exchange assembly 300, get heated in portion 310, and then be emitted out through outputs 308. Note that the nodes or junctions 322 where pipes 318 cross pipes 320 may or may not include passageways between the pipes 318, 320. If passageways exist, air may flow between pipes 318 and 320 in these junctions 322. However, if passageways do not exist, air may not flow between the pipes, 318, 320. It should be noted that some junctions 322 may include passageways between pipes 318, 320 and other junctions 322 may not.

In the example above, it should be noted that the number and configuration of pipes 318, 320 are only meant as a general representation, and that pipe grid 316 may include any number and/or configuration of pipes 318, 320. For example, pipe grid 316 may include the same or a different number of pipes 318 than pipes 320, only pipes 318, only pipes 320, or any combination thereof. In addition, pipes 318 may not necessarily all be parallel with each other, and pipes 320 may not necessarily all be parallel with each other or perpendicular to pipes 318. Also, the inputs 306 and outputs 308 may be configured in any manner or location as described in the embodiments above, and air blowers 304 may be configured with any of the inputs accordingly. In addition, air blowers 304 may also be configured with pipe grid 316 to inject air into nodes 322 or into other areas of the pipe grid 316.

In another example as shown in FIG. 4, heat exchange assembly 300 may comprise a pipe spider 324 that may have a central section 326 with radial pipes 328 that may extend from central section 326 to output ports 308. In addition, central section 326 may include one or more input ports 306 that may be configured with one or more air blowers 304. In this way, air blower 304 may inject pressurized air into central section 326 so that it may flow through portion 310 to be heated and then outward through the remainder of radial pipes 328 to be released through output ports 308. As shown in FIG. 4, portion 310 may include at least a portion of central section 326 as well as a portion of radial pipes 328. Also, the outputs 308 may be configured in any manner or location as described in the embodiments above. Note also that one or more air blowers 304 may also be configured with pipe spider 324 to inject pressurized air into any component of pipe spider 324 that may or may not include input port 306 of central section 326.

Also, pipe spider 324 may include any number of radial pipes 328 that may extend from any number of central sections 326. That is, pipe spider 324 may comprise a network of central sections 326 and radial pipes 328 that may be configured with each other in any manner. In addition, pipe spider 324 may include concentric rings of tubes that encircle central section 326 while tying radial pipes 328 together.

Other configurations of heat exchange assembly 300 may include one or more spirals, zig-zags, ladders, crisscrosses, or other types or combinations of types of networks or configurations that may allow for air to be injected into the assembly 300, heated by portion 310 and then emitted from display 10 to provide warmth to its surroundings. It may also be preferable that output ports 308 of heat exchange assembly 300 be located somewhat symmetrically about container 100 so that the heat provided by the assembly 300 may be generally radiated symmetrically outward from display 10 during operation. However, this may not be required.

Regarding portion 310, it may be preferable to maximize the size of portion 310 and its percentage of the overall size/volume of heat exchange assembly 300 that may be located inside container 100. For example, it may be preferable for portion 310 to represent at least 50% of heat exchange assembly 300 contained inside container 100. In addition, it may be preferable for portion 310 to represent an even larger percentage such as 70%, 80% or 90%. By maximizing the size of portion 310, the amount of air within portion 310 heated by flames 206 may also be maximized such that display 10 may provide more warmth.

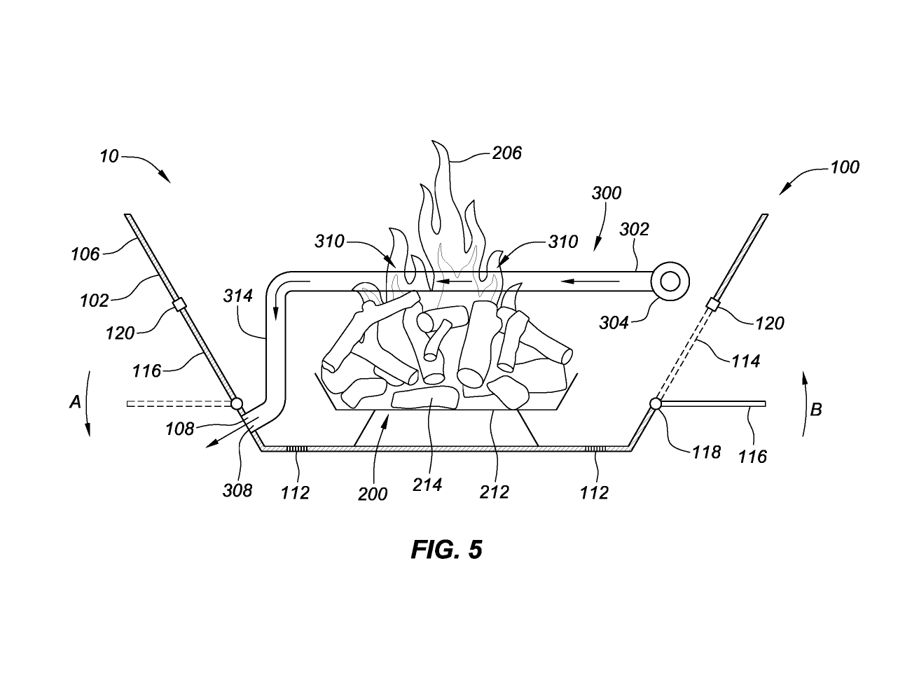

In another example as depicted in FIGS. 5, 6 and 7, combustion source 200 may utilize other combustible materials other than flammable gas such as wood, coal or other combustible materials. In the example depicted in FIG. 5, display 10 may include a holder 212 that may support, contain or otherwise hold combustible material 214. Holder 212 may include a metal frame or other type of device that may adequately support and hold combustible material 214 while it burns. As mentioned above, combustible material 214 may be wood, coal or other types or combinations of types of combustible materials.

Note that the details described in the above examples and embodiments of display 10 with regards to container 100 and heat exchange assembly 300 also apply to this embodiment as well and that this example in no way limits the invention. In addition, it can be seen in FIG. 5 that container 100 may also include door 116 in side 106 that when opened creates opening 114. The purpose for opening 114 may be to allow the combustible material 214 to be placed inside container 100 and onto holder 212 to be burned. In this way, combustible material 214 may be positioned below heat exchange assembly 300 such that portion 310 may be above combustible material 214 to optimize the heat transfer that it may receive from flames 206.

Door 116 may open by rotating downward about hinge mechanism 118 as shown by arrow A. Note that door 116 may also rotate upward, to the side or in any direction such that it may open and create opening 114. Door 116 may also slide open or open in any other way. Door 116 may be closed by rotating it upward in the direction of arrow B and releasably securing it to side 106 with locking member 120. Locking member may include a latch, snap, lock, tab or other type of locking mechanism. Note that for demonstration purposes, door 116 on the right side of container 100 in FIG. 5 is depicted as open (and with dashed lines depicting where it may be positioned when closed), and that door 116 on the left side of container 100 is depicted as closed (with the dashed lines depicting where it may be positioned when open). However, note that any number of doors 116 may be utilized and positioned in any number of locations on container 100 that may adequately allow combustible material 214 to be placed within container 100 to be burned. It may also be preferable that all doors 116 be closed while display 10 is in operation.

In this configuration it can be seen that combustion source 200 (in this case combustible material such as wood or coal) may provide flames 206 that may heat portion 310 of heat exchange assembly 300, and that display 10 may provide both visual effects and heat as described in the above embodiments.

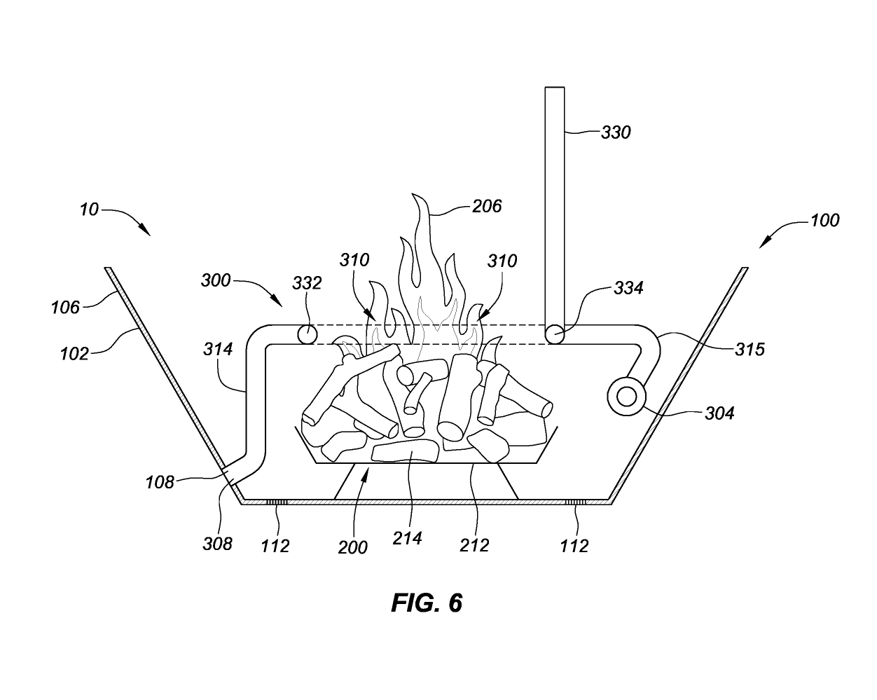

In another example of this type, heat exchange assembly 300 may include a section that may be temporarily repositioned to gain access to the inside of container 100 such that combustible material 214 may be placed on holder 212. In one example as depicted in FIG. 6, heat exchange assembly 300 may include section 330 that may rotate upward in the direction of arrow C about rotatable mount 334. Rotatable mount 334 may comprise a hinge or other type mount that may allow section 330 to rotate or be generally repositioned.

Once section 330 may be in the upper position, an opening may be formed in the top of container 100 and the combustible material 214 may be placed through the opening and onto holder 212. After this is completed, section 330 may be rotated back downward in the direction of arrow D and reconfigured with rest of heat exchange assembly 300 at junction 332. This is depicted by the dashed lines in FIG. 6. It may be preferable that junction 332 receives section 330 such that section 330 may recombine with the other components and sections of heat exchange assembly 300 in an airtight manner free of holes or gaps, and that the inner passageways for the air to pass may be unobstructed.

Note that section 330 may or may not include portion 310. Either way, it should be clear that portion 310 may be positioned directly above flames 206 during operation of display 10 in order to maximize the heat transfer between flames 206 and portion 310 as described above.

It should also be noted that the example depicted in FIG. 6 is meant for demonstration purposes only and that one or more sections 330 of heat exchange assembly 300 may be repositioned. For example, section 330 may include a portion or all of grid 316 of air tubes 318, 320 in the embodiment described above in relation to FIG. 3 such that they may rotate upward or otherwise be repositioned to allow access to holder 212. In addition, different sections 330 separate from each other may each include different rotatable mounts 320 to rotate in different directions and/or orientations. It can be seen that any section 330 of heat exchange assembly 300 may be rotated or otherwise repositioned in any direction. Note also that the details described in the above examples and embodiments of display 10 with regards to container 100 and heat exchange assembly 300 also apply to this embodiment as well and that this example in no way limits the invention.

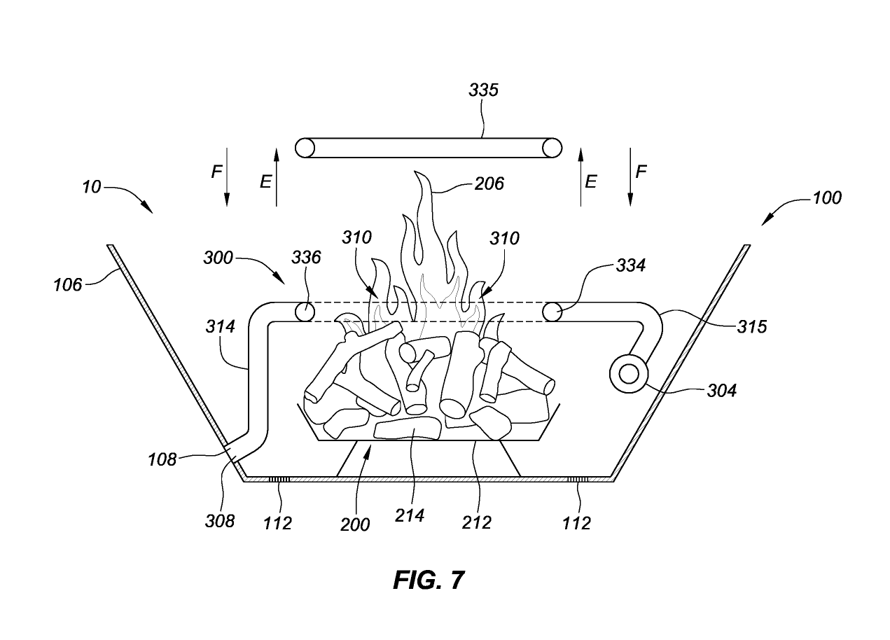

In another example as depicted in FIG. 7, section 335 of heat exchange assembly 300 may be removed to gain access to the inside of container 100 such that combustible material 214 may be placed on holder 212. For example, section 335 may be disengaged and generally lifted in the direction of arrows E.

Once section 335 may be lifted, an opening may be formed in the top of container 100 and the combustible material 214 may be placed through the opening and onto holder 212. After this is completed, section 335 may be replaced in the direction of arrows F and reconfigured with rest of heat exchange assembly 300 at junctions 336, 338. This is depicted by the dashed lines in FIG. 7. It may be preferable that junctions 336, 338 receive section 335 such that section 335 may recombine with the other components and sections of heat exchange assembly 300 in an airtight manner free of holes or gaps, and that the inner passageways for the air to pass may be unobstructed.

Note that section 335 may or may not include portion 310. Either way, it should be clear that portion 310 may be positioned directly above flames 206 during operation of display 10 in order to maximize the heat transfer between flames 206 and portion 310 as described above.

It should also be noted that the example depicted in FIG. 7 is meant for demonstration purposes only and that one or more sections 335 of heat exchange assembly 300 may be repositioned. For example, section 335 may include a portion or all of grid 316 of air tubes 318, 320 in the embodiment described above in relation to FIG. 3 such that they may be removed or otherwise be repositioned to allow access to holder 212. In addition, different sections 335 separate from each other may be removed. It can be seen that any section 335 of heat exchange assembly 300 may be removed or otherwise repositioned in any direction. Note also that the details described in the above examples and embodiments of display 10 with regards to container 100 and heat exchange assembly 300 also apply to this embodiment as well and that this example in no way limits the invention.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A display, comprising:
a container;
a source of combustion within the container;
at least one pipe with an input and an output and a portion positioned above the source of combustion; and
a source of pressurized air that injects pressurized air into the input of the pipe;
wherein the air travels into the input of the pipe, through the portion positioned above the source of combustion and out the output.

2. The display of claim 1, wherein the portion of the pipe positioned above the source of combustion is heated by the source of combustion.

3. The display of claim 2, wherein the air that travels through the portion of the pipe heated by the source of combustion is heated by the portion of the pipe.

4. The display of claim 3, wherein the heated air is released out the output of the pipe.

5. The display of claim 1, wherein the output of the pipe is located below the portion of the pipe that is positioned above the source of combustion.

6. The display of claim 5, further comprising a downward section of pipe that connects the portion of the pipe that is positioned above the source of combustion to the output.

7. The display of claim 1, wherein the source of combustion is a gas burner.

8. The display of claim 7, wherein the portion of the pipe that is positioned above the source of combustion passes through the primary flame of the gas burner.

9. The display of claim 1, wherein the pipe includes a pipe grid.

10. The display of claim 2, wherein the pipe includes a pipe spider.

11. A display, comprising:
a container;
a source of combustion within the container;
at least one pipe with an input and an output and a portion positioned above the source of combustion that is heated by the source of combustion; and
a source of pressurized air that injects pressurized air into the input of the pipe;
wherein the air travels into the input of the pipe, through the heated portion and out the output; and
wherein the air traveling through the heated portion of the pipe is heated by the portion of the pipe.

12. The display of claim 11, wherein the output of the pipe is located below the portion of the pipe that is positioned above the source of combustion.

13. The display of claim 12, further comprising a downward section of pipe that connects the portion of the pipe that is positioned above the source of combustion to the output.

14. The display of claim 1, wherein the source of combustion is a gas burner.

15. The display of claim 14, wherein the portion of the pipe that is positioned above the source of combustion passes through the primary flame of the gas burner.

16. The display of claim 11, wherein the pipe includes a pipe grid and/or a pipe spider.

17. A display, comprising:
a container;
a source of combustion within the container;
at least one pipe with an input and an output and a portion positioned above the source of combustion that is heated by the source of combustion, and said output positioned below said portion;
a downward section of pipe that connects the portion of pipe heated by the source of combustion and the output; and
a source of pressurized air that injects pressurized air into the input of the pipe;
wherein the air travels into the input of the pipe, through the heated portion and out the output; and
wherein the air traveling through the heated portion of the pipe is heated by the portion of the pipe.

18. The display of claim 1, wherein the source of combustion is a gas burner.

19. The display of claim 14, wherein the portion of the pipe that is positioned above the source of combustion passes through the primary flame of the gas burner.

20. The display of claim 11, wherein the pipe includes a pipe grid and/or a pipe spider.
